(19) United States
(12) Patent Application Publication
(10) Pub. No.: US 2010/0058897 A1
(43) Pub. Date: Mar. 11, 2010

(54) SINGLE AND UNITARILY FORGED SOCKET

(76) Inventor: Randall A. Alsobrook, Bedford, TX (US)

Correspondence Address: Michael A. O'Neil. P.C., 8150 North Central Expressway, Suite 1150, DALLAS, TX, 75206, US

(21) Appl. No.: 12/207,529

(22) Filed: Sep. 10, 2008

(51) Int. Cl. B25B 13/06

(52) U.S. Cl. 81/121.1

(57) ABSTRACT

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. A single and unitarily forged socket includes a cylindrical body that has opposed proximal and distal ends and has a centrally registered first bore formed therein.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a front elevation view showing an easy grip socket for allowing an operator to effectively maintain a static grip on the socket during working conditions, in accordance with the present invention;

FIG. 2 is a rear elevation of the apparatus shown in FIG. 1;

FIG. 3 is a side elevation view of the apparatus shown in FIG. 1 showing the indentation formed in the outer surface thereof;

FIG. 4 is a top plan view of the apparatus shown in FIG. 1, showing the first bore formed therein;

FIG. 5 is a bottom plan view of the apparatus shown in FIG. 1, showing the second bore formed therein;

FIG. 6 is an enlarged perspective view of the apparatus shown in FIG. 1;

FIG. 7 is a front elevation view showing an alternate embodiment of the apparatus shown in FIG. 1;

FIG. 8 is a rear elevation of the apparatus shown in FIG. 7;

FIG. 9 is a side elevation view of the apparatus shown in FIG. 7;

FIG. 10 is a top plan view of the apparatus shown in FIG. 7, showing the first bore formed therein;

FIG. 11 is a bottom plan view of the apparatus shown in FIG. 7, showing the second bore formed therein; and

FIG. 12 is an enlarged perspective view of the apparatus shown in FIG. 7.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A conventional socket, in accordance with the prior art, has a hexagonal recess defined in one end thereof, and further has a thickest portion and a thinnest portion. In use, the socket can be fitted on a work-piece such as a nut, a bolt or the like. A user can then hold the outer periphery of the socket to rotate the socket around a number of turns so as to slightly tighten the work-piece manually. Then, the socket is operated in conjunction with a socket wrench so as to tighten the work-piece. However, the outer periphery of conventional sockets are often made round with a smooth surface so that the user cannot securely hold the outer periphery thereof, thereby causing the user's hand to slip when rotating the socket.

In an attempt to overcome the above-noted problem, one prior art example introduces a molded elastomeric sleeve that is carried on a conventional wrench socket. The sleeve has suitable knurls formed on the outer diameter of the sleeve, which prevent the socket from rolling, if placed sideways on a flat surface. Such knurls also facilitate the manual rotation of the socket.

After forming, the sleeve is axially oriented and slidably positioned on a portion of the socket. Adhesive is then injected into the annular groove via the radial passageway for retaining the sleeve about the socket. Unfortunately, this is a time consuming and expensive process that adds such significant costs to the final socket, so as to make it unaffordable to a majority of mechanics and technicians, as well as do-it-yourself enthusiasts. Furthermore, the knurls formed in the surface of the sleeve have a tendency to wear off over extended periods of time, thus eliminating the benefit of providing a surface with increased grip.

Accordingly, a need remains for a socket in order to overcome the above noted shortcomings. The present invention satisfies such a need by providing a socket that is easy and convenient to use, durable in design, reasonably priced, and allows for slight manual adjustments to be easily made therewith. Such an etched socket is still rotatable by hand, even though the user's hand is covered in grease or oil that would otherwise cause their fingers to slip about the socket. This is especially helpful when an individual is working in a confined and hard to reach area, such as the engine compartment of an automobile.

Embodiments of the present invention include easy grip sockets for allowing an operator to effectively maintain a static grip on the socket during working conditions. The socket includes a cylindrical body that has axially opposed proximal and distal end portions. Such a body further has a centrally registered first bore formed therein. The first bore has a square cross-section medially positioned within the proximal end portion and terminates proximal to the distal end portion.

The body further has a centrally registered second bore formed therein. Such a second bore has a symmetric shape provided with a diameter greater than a diameter of the first bore. The first and second bores are spaced from each other.

A mechanism is included for advantageously preventing the operator from loosing a grip of the body when a hand of the operator and the body is covered in grease. Such a preventing mechanism is monolithically formed with an outer surface of the body and is permanently forged as a single unit directly therewith. The preventing mechanism rotates in sync with the outer surface of the socket. Such a preventing mechanism is spaced between the proximal and distal end portions and is outwardly situated from the first and second bores such that a selected portion of the body seated adjacent to the first and second bores maintains a continuous and smooth shape respectively. The preventing mechanism and the body are formed from non-corrosive material.

An embodiment of the preventing mechanism includes a plurality of cross-hatched members formed in the outer surface of the body. Such cross-hatched members effectively create a course surface that maintains a static orientation during operating conditions. The preventing mechanism may further include an indentation partially formed in the outer surface of the body. Such an indentation directly contacts the cross-hatched members and has a depressed lip extending about an outer perimeter of the indentation for advantageously and effectively creating a region onto which the operator's hand can engage and maintain static surface area contact with the body during operating conditions.

In an alternate embodiment, the preventing mechanism includes a plurality of elongated and rectilinear ribs that are directly conjoined to the outer surface of the body and extend parallel to a longitudinal axis of the body. Such ribs are coextensively shaped and have opposed end portions terminating inwardly of the proximal and distal end portions respectively. Each of the ribs protrudes outwardly and away from the outer surface and is equidistantly spaced there along such that the hand of the operator can advantageously and effectively maintain frictional contact with the body during operating conditions.

Each of the ribs may have a triangular cross-section provided with an apex formed at a maximum distance from the outer surface. Each of the apexes provides a rough edge onto which the operator hand may conveniently firmly grip the body and effectively prevent the socket from slipping away there from. In this embodiment, the ribs are equidistantly offset from the longitudinal axis. The maximum distance has a value of less than one-sixteenth of one inch in this embodiment.

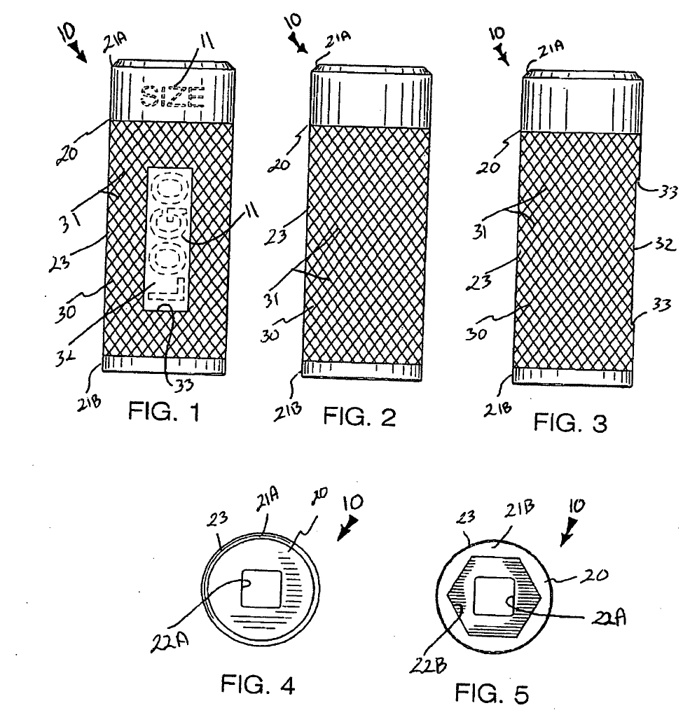

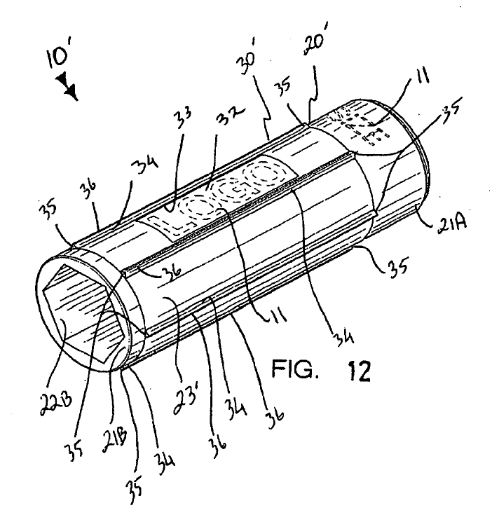

The apparatus of this invention is referred to generally in FIGS. 1-12 by the reference numeral 100 and is intended to provide a single and unitarily forged socket. It should be understood that the apparatus 100 may be used to provide improved grip for many different types of sockets and should not be limited in use to only metric sockets.

Referring initially to FIGS. 1 through 6, the apparatus 100 includes a cylindrical body 120 that has axially opposed proximal 121A and distal 121B end portions, and also has a suitable longitudinal length for being manually grasped by user, which is an essential feature for allowing the apparatus 100 to be adjusted, by hand, in small increments. Of course, the body 120 may be produced in a variety of longitudinal lengths, as is obvious to a person of ordinary skill in the art. Such a body 120 further has a centrally registered first bore 122A formed therein. The first bore 122A has a square cross-section medially positioned within the proximal end portion 121A and terminates proximal to the distal end portion 121B.

Such a square first bore 122A provides a connecting surface by which the apparatus 100 can conveniently be connected to a variety of conventional socket wrenches (not shown). Of course, the first bore 122A may be produced in a variety of alternate shapes and sizes for fitting onto different types of wrenches, as is obvious to a person of ordinary skill in the art. The body 120 further has a centrally registered second bore 122B formed therein. Such a second bore 122B has a symmetric shape provided with a diameter greater than a diameter of the first bore 122A. Of course, the second bore 122B may be produced in a variety of alternate shapes and diameters, on both the standard and the metric scale, for effectively engaging variously shaped and sized fasteners, as is obvious to a person of ordinary skill in the art. The first 122A and second bores 122B are spaced from each other.

Referring to FIGS. 1, 2, 3 and 6, a mechanism 130 is included for advantageously preventing the operator from loosing a grip of the body 120 when a hand of the operator and the body 120 is covered in grease. This is especially true when a user, such as a mechanic, must reach into tight spaces in order to loosen/fasten a fastener where their wrench can not properly be operated. Such a preventing mechanism 130 is monolithically formed with an outer surface 123 of the body 120 and is permanently conjoined directly, without the use of intervening elements, therethrough. This feature ensures that the preventing mechanism 130 is always functional, unlike the prior art examples where the gripping surfaces are formed as separate entities from the body, often leading to such gripping surfaces wearing off or becoming disconnected from the body.

The preventing mechanism 130 rotates in sync with the outer surface 123 of the socket 100, which is critical and advantageous for ensuring that grip does not loosen during the entire rotation of the apparatus 100. Such a preventing mechanism 130 is spaced between the proximal 121A and distal 121B end portions and is outwardly situated from the first 122A and second 122B bores so that a selected portion of the body 120 seated adjacent to the first 122A and second 122B bores maintains a continuous and smooth shape respectively. In this embodiment, the preventing mechanism 130 and the body 120 are formed from non-corrosive material, which is an advantageous feature for ensuring that the apparatus 100 is not adversely affected by various corrosive materials often encountered within the environments where the apparatus 100 is employed.

Referring to FIGS. 1, 2, 3 and 6, the preventing mechanism 130 includes a plurality of cross-hatched members 131 formed in the outer surface 123 of the body 120. Such cross-hatched members 131 effectively create a course surface that maintains a static orientation during operating conditions. The cross-hatched nature of the course surface also advantageously ensures that a suitable grip is provided during both clockwise and counterclockwise rotations.

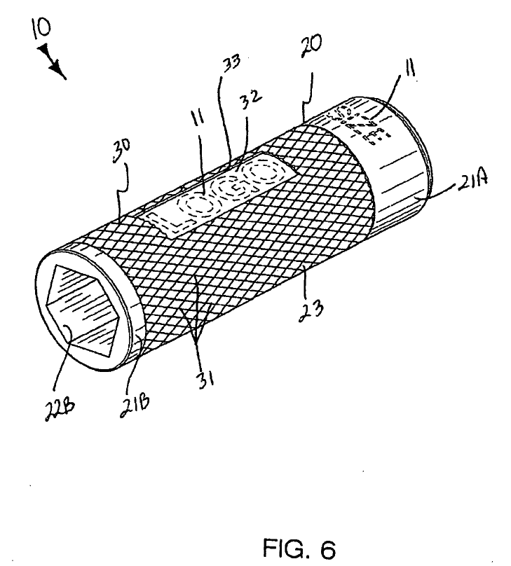

The preventing mechanism 130 further includes an indentation 132 partially formed in the outer surface 123 of the body 120. Such an indentation 132 is monolithically forged with the body 120 as a single and unitary apparatus 100. Thus, without the use of intervening elements, the cross-hatched members 131 and has a depressed lip 133 extending about an outer perimeter of the indentation 132 that advantageously and effectively creates a region onto which the operator's hand can engage and maintain static surface area contact with the body 120 during operating conditions. Of course, as is shown in FIGS. 1 and 6, the indentation 132 and the proximal end 121A may have surface indicia 111 printed thereon or etched therein for conveniently indicating a logo of a manufacturer and the size of the second bore 122B respectively, as is obvious to a person of ordinary skill in the art.

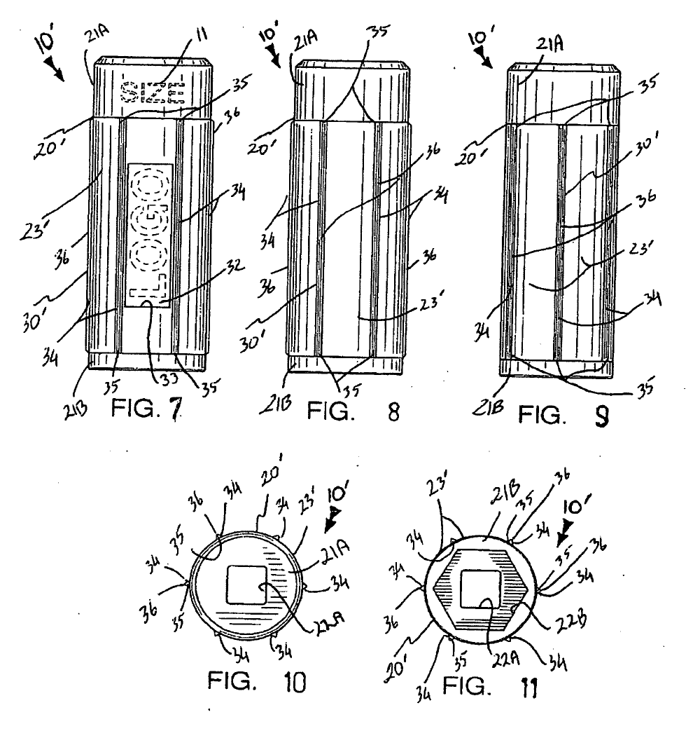

Referring to FIGS. 7 through 12, in an alternate embodiment 200, the preventing mechanism 230 includes a plurality of elongated and rectilinear ribs 234 that are unitarily forged and monolithically formed with the body 220, without the use of intervening elements, to the outer surface 223 of the body 220 and extend parallel to a longitudinal axis of the body 220. The parallel orientation of the ribs 234, with respect to the longitudinal axis of the body 220, ensures that frictional and resistive forces are provided by the ribs 234 as a user rotates the apparatus 200 in either a clockwise of counterclockwise fashion. Such ribs 234 are coextensively shaped and have opposed end portions 235 terminating inwardly of the proximal 221A and distal 221B end portions respectively.

In this embodiment, each of the ribs 234 protrudes outwardly and away from the outer surface 223 and is equidistantly spaced there along, which allows the operator's hand to advantageously and effectively maintain frictional contact with the body 220 during operating conditions. Each of the ribs 234 has a triangular cross-section provided with an apex 236 formed at a maximum distance from the outer surface 223. In addition, each of the apexes 236 provide a rough edge onto which the operator's hand can conveniently firmly grip the body 220 and effectively prevent the socket 200 from slipping away there from. In this embodiment, the ribs 234 are equidistantly offset from the longitudinal axis. In this embodiment, the maximum distance has a value of less than one-sixteenth of one inch. Of course, the maximum distance between adjacent ribs 234 may greater than the above mentioned maximum distance, as is obvious to a person of ordinary skill in the art.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A single and unitarily forged socket comprising:
a cylindrical body having axially opposed proximal and distal end portions, the body further having a centrally registered first bore formed therein, the first bore having a square cross-section medially positioned within the proximal end portion and terminating proximal to the distal end portion, the body further having a centrally registered second bore formed therein, the second bore having a symmetric shape provided with a diameter greater than a diameter of the first bore, the first and second bores being spaced from each other; and
a plurality of ridges for preventing the operator from loosing a grip of the body when a hand of the operator is slippery, the ridges being monolithically formed with an outer surface of the body and unitarily forged directly therewith;
wherein the ridges is spaced between the proximal and distal end portions and is outwardly situated from the first and second bores such that a selected portion of the body seated adjacent to the first and second bores maintains a continuous and smooth shape respectively.

2. The socket of claim 1, wherein the plurality of ridges comprises:
a plurality of cross-hatched members formed in the outer surface of the body, the cross-hatched members creating a course surface and maintaining a static orientation during operating conditions.

3. The socket of claim 2, wherein the preventing means comprises:
an indentation partially formed in the outer surface of the body, the indentation directly contacting the cross-hatched members and having a depressed lip extending about an outer perimeter of the indentation for creating a region onto which the operator hand can engage and maintain static surface area contact with the body during operating conditions.

4. The socket of claim 1, wherein the plurality of ridges comprises:
a plurality of elongated and rectilinear ribs directly conjoined to the outer surface of the body and extending parallel to a longitudinal axis of the body, the ribs being coextensively shaped and having opposed end portions terminating inwardly of the proximal and distal end portions respectively, each of the ribs protruding outwardly and away from the outer surface and being equidistantly spaced there along such that the operator hand can maintain frictional contact with the body during operating conditions.

5. The socket of claim 4, wherein each of the ribs has a triangular cross-section provided with an apex formed at a maximum distance from the outer surface, each of the apexes providing a rough edge onto which the operator hand may firmly grip the body and prevent the socket from slipping away there from.

6. The socket of claim 4, wherein the ribs are equidistantly offset from the longitudinal axis, the maximum distance having a value of about less than one-sixteenth of one inch.

7. A single and unitarily forged socket comprising:
a cylindrical body having axially opposed proximal and distal end portions, the body further having a centrally registered first bore formed therein, the first bore having a square cross-section medially positioned within the proximal end portion and terminating proximal to the distal end portion, the body further having a centrally registered second bore formed therein, the second bore having a symmetric shape provided with a diameter greater than a diameter of the first bore, the first and second bores being spaced from each other; and
a plurality of ridges for preventing the operator from loosing a grip of the body when a hand of the operator is slippery, the ridges being monolithically formed with an outer surface of the body and permanently conjoined directly therethrough;
wherein the preventing means is spaced between the proximal and distal end portions and is outwardly situated from the first and second bores such that a selected portion of the body seated adjacent to the first and second bores maintains a continuous and smooth shape respectively; and wherein the ridges and the body are formed from non-corrosive material.

8. The socket of claim 7, wherein the plurality of ridges comprises:
a plurality of cross-hatched members formed in the outer surface of the body, the cross-hatched members creating a course surface and maintaining a static orientation during operating conditions.

9. The socket of claim 8, wherein the plurality of ridges comprises:
an indentation partially formed in the outer surface of the body, the indentation directly contacting the cross-hatched members and having a depressed lip extending about an outer perimeter of the indentation for creating a region onto which the operator hand can engage and maintain static surface area contact with the body during operating conditions.

10. The socket of claim 7, wherein the plurality of ridges comprises:
a plurality of elongated and rectilinear ribs directly conjoined to the outer surface of the body and extending parallel to a longitudinal axis of the body, the ribs being coextensively shaped and having opposed end portions terminating inwardly of the proximal and distal end portions respectively, each of the ribs protruding outwardly and away from the outer surface and being equidistantly spaced there along such that the operator hand can maintain frictional contact with the body during operating conditions.

11. The socket of claim 10, wherein each of the ribs has a triangular cross-section provided with an apex formed at a maximum distance from the outer surface, each of the apexes providing a rough edge onto which the operator hand may firmly grip the body and prevent the socket from slipping away there from.

12. The socket of claim 10, wherein the ribs are equidistantly offset from the longitudinal axis, the maximum distance having a value of about less than one-sixteenth of one inch.

13. A single and unitarily forged socket comprising:
a cylindrical body having axially opposed proximal and distal end portions, the body further having a centrally registered first bore formed therein, the first bore having a square cross-section medially positioned within the proximal end portion and terminating proximal to the distal end portion, the body further having a centrally registered second bore formed therein, the second bore having a symmetric shape provided with a diameter greater than a diameter of the first bore, the first and second bores being spaced from each other; and
a plurality of ridges for preventing the operator from loosing a grip of the body when a hand of the operator is slippery, the plurality of ridges being monolithically formed with an outer surface of the body and unitarily forged directly therewith, wherein the plurality of ridges rotates in sync with the outer surface of the socket;
wherein the plurality of ridges is spaced between the proximal and distal end portions and is outwardly situated from the first and second bores such that a selected portion of the body seated adjacent to the first and second bores maintains a continuous and smooth shape respectively; and wherein the plurality of ridges and the body are formed from non-corrosive material.

14. The socket of claim 13, wherein the plurality of ridges comprises:
a plurality of cross-hatched members formed in the outer surface of the body, the cross-hatched members creating a course surface and maintaining a static orientation during operating conditions.

15. The socket of claim 14, wherein the plurality of ridges comprises:
an indentation partially formed in the outer surface of the body, the indentation directly contacting the cross-hatched members and having a depressed lip extending about an outer perimeter of the indentation for creating a region onto which the operator hand can engage and maintain static surface area contact with the body during operating conditions.

16. The socket of claim 13, wherein the plurality of ridges comprises:
a plurality of elongated and rectilinear ribs directly conjoined to the outer surface of the body and extending parallel to a longitudinal axis of the body, the ribs being coextensively shaped and having opposed end portions terminating inwardly of the proximal and distal end portions respectively, each of the ribs protruding outwardly and away from the outer surface and being equidistantly spaced there along such that the operator hand can maintain frictional contact with the body during operating conditions.

17. The socket of claim 16, wherein each of the ribs has a triangular cross-section provided with an apex formed at a maximum distance from the outer surface, each of the apexes providing a rough edge onto which the operator hand may firmly grip the body and prevent the socket from slipping away there from.

18. The socket of claim 16, wherein the ribs are equidistantly offset from the longitudinal axis, the maximum distance having a value of less than one-sixteenth of one inch.
